(19) United States
(12) Patent Application Publication
(10) Pub. No.: US 2011/0203178 A1
(43) Pub. Date: Aug. 25, 2011

(54) CASE COVER STRUCTURE FOR FALL PREVENTION

(76) Inventor: Chun-Pu HSU, Taipei County (TW)

(21) Appl. No.: 12/708,967

(22) Filed: Feb. 19, 2010

(51) Int. Cl. E06B 7/00; E05F 15/00

(52) U.S. Cl. 49/70

(57) ABSTRACT

A case cover structure for fall prevention which is applied in automatic sliding doors is disclosed. The structure includes a main frame, at least one bearing plate, at least one absorption element and a cover. The bearing plate is fixed on the main frame and has a receiving groove. The absorption element is disposed in the receiving groove of the bearing plate. The cover is disposed on one side of the main frame and has a corresponding groove opposite to the receiving groove. An absorbed element is disposed in the corresponding groove. The absorption element absorbs and fixes the absorbed element so that the cover is fixed on one side of the main frame. Accordingly, the present invention can effectively prevent the case cover for an automatic door from falling during maintenance and enhance convenience and security for maintenance.

### BACKGROUND OF THE INVENTION

1. Field of the Invention

The present invention relates to a case cover structure for fall prevention, and more particularly to a case cover structure for fall prevention for automatic door cases.

2. Description of Related Art

Please refer to FIG. 1, a conventional automatic door case includes a main frame 1a, a cover 2a, a driving motor 3a and a plurality of lift tools 4a. The driving motor 3a and the lift tools 4a are disposed in the main frame 1a, and the driving motor 3a is used for driving the lift tools 4a to move and the lift tools 4a are slidably disposed on a guideway 11a in the main frame 1a. Door leafs (not shown) are fixed on the bottoms of the lift tools 4a. The cover 2a is locked on one side of the main frame 1a via screws 5a.

However, an automatic door case is generally mounted on a ceiling or a high position of the wall, so when parts in the automatic door case break down, maintenance workers must work aloft to remove the screws 5a on the cover 2a of the automatic door case, so as to disassemble the cover 2a for maintenance. Since no fixing structure is fixed on the cover 2a, maintenance workers must hold the cover 2a so that it is quite inconvenient for disassembling or assembling the cover 2a, and further, the falling of the cover 2a endangers the safety of maintenance workers during maintenance.

Hence, the inventors of the present invention believe that the shortcomings described above are able to be improved and finally suggest the present invention which is of a reasonable design and is an effective improvement based on deep research and thought.

### SUMMARY OF THE INVENTION

A main objective of the present invention is to provide a case cover structure for fall prevention which can effectively prevent a case cover for an automatic door from falling during maintenance and enhance convenience and security for maintenance.

To achieve the above-mentioned objective, a case cover structure for fall prevention in accordance with the present invention is provided. The case cover structure for fall prevention, which is applied in automatic sliding doors, includes a main frame; at least one bearing plate which is fixed on the main frame and has a receiving groove; at least one absorption element disposed in the receiving groove of the bearing plate; and a cover which is disposed on one side of the main frame and has a corresponding groove opposite to the receiving groove, wherein an absorbed element is disposed in the corresponding groove, and the absorption element absorbs and fixes the absorbed element so that the cover is absorbed and fixed on one side of the main frame.

The present invention further provides a case cover structure for fall prevention which is applied in automatic sliding doors. The case cover structure for fall prevention includes a main frame having a revolving groove and a supporting portion formed in one side thereof, the supporting portion located at an opening of the revolving groove; and a cover disposed on one side of the main frame and having a hook portion and a protruding portion formed on one end of the cover, wherein the cover may move between a first position and a second position, and when the cover is in the first position, the hook portion correspondingly holds the supporting portion; and when the cover is in the second position, one end of the cover extends into the revolving groove, the bottom of the cover abuts against the supporting portion and the protruding portion abuts against a top wall in the revolving groove of the main frame so that the cover is fixed on one side of the main frame.

The present invention further provides a case cover structure for fall prevention which is applied in automatic doors. The case cover structure for fall prevention includes a main frame having a revolving groove and a supporting portion formed in one side thereof, wherein the supporting portion is located at an opening of the revolving groove and a protruding rib protrudes from a top wall opposite to the revolving groove; and a cover which is disposed on one side of the main frame and has a hook portion and a protruding portion formed on one end of the cover, wherein the cover may move between a first position and a second position, and when the cover is in the first position, the hook portion correspondingly holds the supporting portion; and when the cover is in the second position, one end of the cover extends into the revolving groove and the protruding portion abuts against the protruding rib so that the cover is fixed on one side of the main frame.

The efficacy of the present invention is as follows:

1. The adsorption element adsorbs and fixes the adsorbed element so that the cover is fixed on one side of the main frame, thereby preventing the cover from falling. Comparing with conventional automatic door, the present invention has more sorption between the cover and the main frame.

2. When the cover is in the second position, the protruding portion of the cover abuts against the top wall opposite to the revolving groove, one end of the cover abuts against the supporting portion and the vertical height of the other end of the cover is slightly higher than the supporting portion, so that the cover is fixed on one side of the main frame, thereby preventing the cover from falling and enhancing convenience for maintenance and security.

3. When the cover is in the second position, the protruding portion of the cover abuts against the protruding rib, so that the cover is fixed on one side of the main frame, thereby preventing the cover from falling and enhancing convenience for maintenance and security.

### BRIEF DESCRIPTION OF THE DRAWINGS

FIG. 1 is a planar schematic view of a conventional automatic door case;

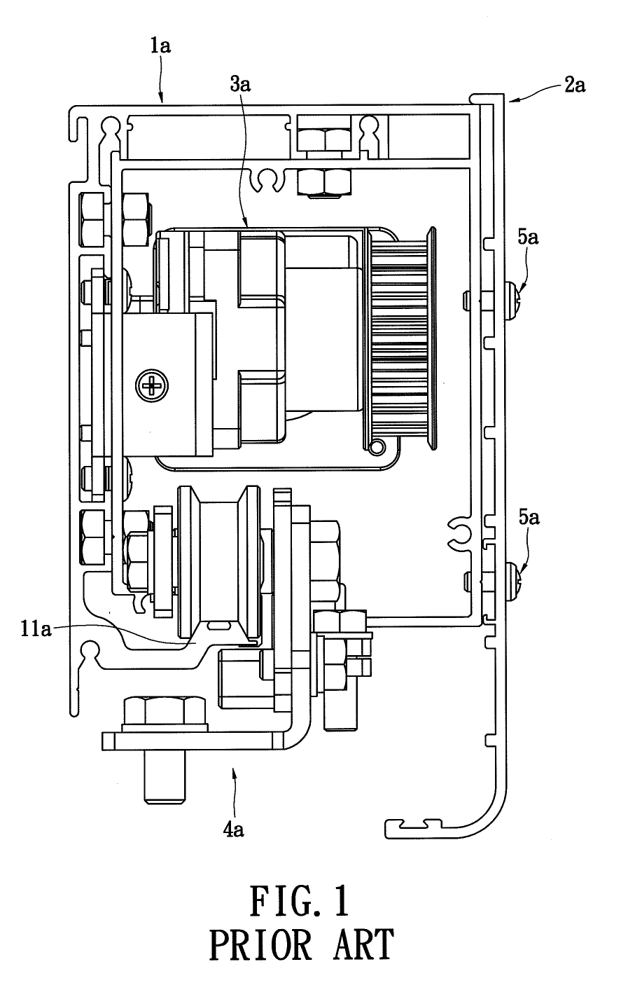

FIG. 2 is a perspective view of a case cover structure for fall prevention of the present invention;

FIG. 3 is a first planar schematic view of the case cover structure for fall prevention of the present invention;

FIG. 4 is a second planar schematic view of the case cover structure for fall prevention of the present invention;

FIG. 5 is a third planar schematic view of the case cover structure for fall prevention of the present invention;

FIG. 6 is a fourth planar schematic view of the case cover structure for fall prevention of the present invention;

FIG. 7 is a fifth planar schematic view of the case cover structure for fall prevention of the present invention; and

FIG. 8 is a planar schematic view of another embodiment of the case cover structure for fall prevention of the present invention.

### DETAILED DESCRIPTION OF THE PREFERRED EMBODIMENTS

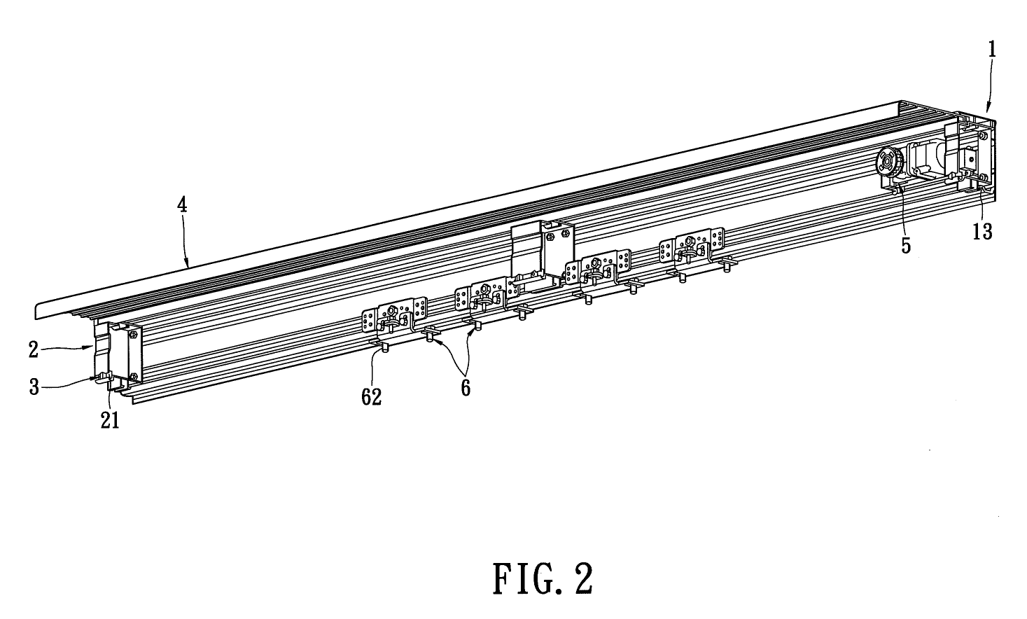

Please refer to FIGS. 2-8 illustrating a case cover structure for fall prevention according to the present invention, which is applied in automatic doors. The case cover structure for fall prevention includes a main frame 1, at least one bearing plate 2, at least one adsorption element 3 and a cover 4.

In the embodiment, the main frame 1, the bearing plate 2 and the cover 4 are formed via extrusion of aluminum. A revolving groove 11 and a supporting portion 12 are formed in one side of an upper segment of the main frame 1, wherein the supporting portion 12 is located at the opening end of the revolving groove 11. A protruding rib 111 is protruded from a top wall in the revolving groove 11 of the main frame 1 for stop. A guideway 13 extends on the other side of a lower segment of the main frame 1. A plurality of fixing grooves 14 are formed in an inner wall of the main frame 1 for engaging with screws S and screw caps H for fixation. Further, a driving motor 5 and at least one lift tool 6 are disposed in the main frame 1, wherein the driving motor 5 is fixed on the main frame 1 via screws 51 and driving-connected with the lift tool 6, and the driving motor 5 may drive the lift tool 6 to slide on the glideway 13 basing on at least one rolling wheel 61. The bottom of the lift tool 6 may be fixed on a door leaf (not shown) via screws 62.

The number of bearing plate 2 isn't limited. The bearing plate 2 is a frame body which is fixed on the inner wall of the main frame 1 via the screws S and the screw caps H, and the bearing plate 2 has a receiving groove 21 in the outside thereof.

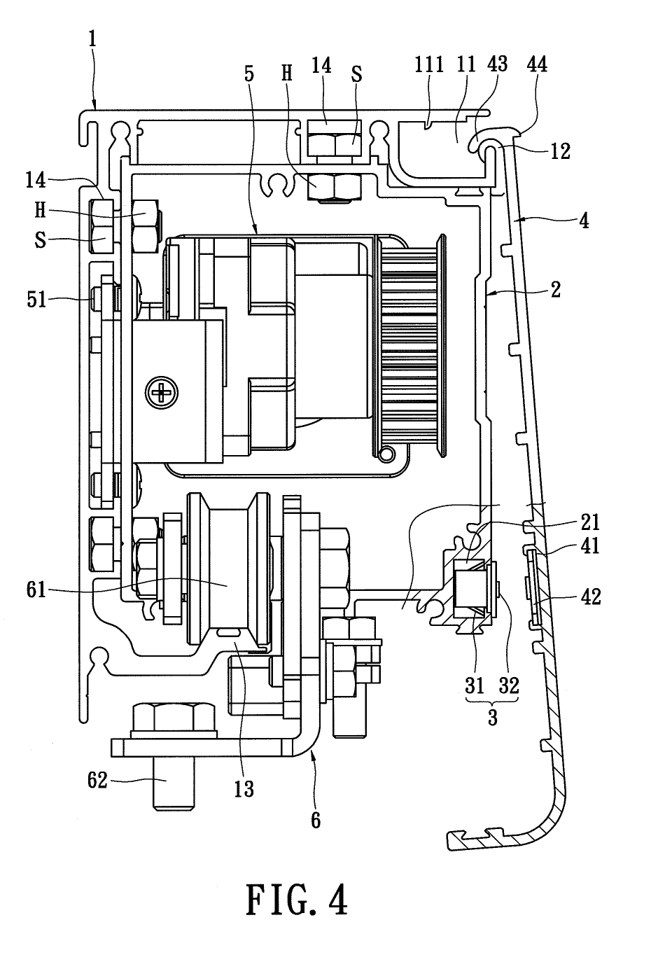

The adsorption element 3 may be a magnetic element or a magnetizer. If the adsorption element 3 is a magnetic element, it has a magnet disposed therein. Two side edges of the adsorption element 3 expand outwards and extend to form two elastic portions 31, and a flexible portion 32 (as shown in FIG. 4) protrudes from the outside of the adsorption element 3. During the assembly of the adsorption element 3, the two elastic portions 31 may be pressed and flattened by the wall of the opening end of the receiving groove 21 so that the adsorption element 3 can successfully enter the receiving groove 21, and then the two elastic portions 31 expand and abut against the inner wall in the receiving groove 21 under elastic restoring forces, thereby the adsorption element 3 is fixed in the receiving groove 21.

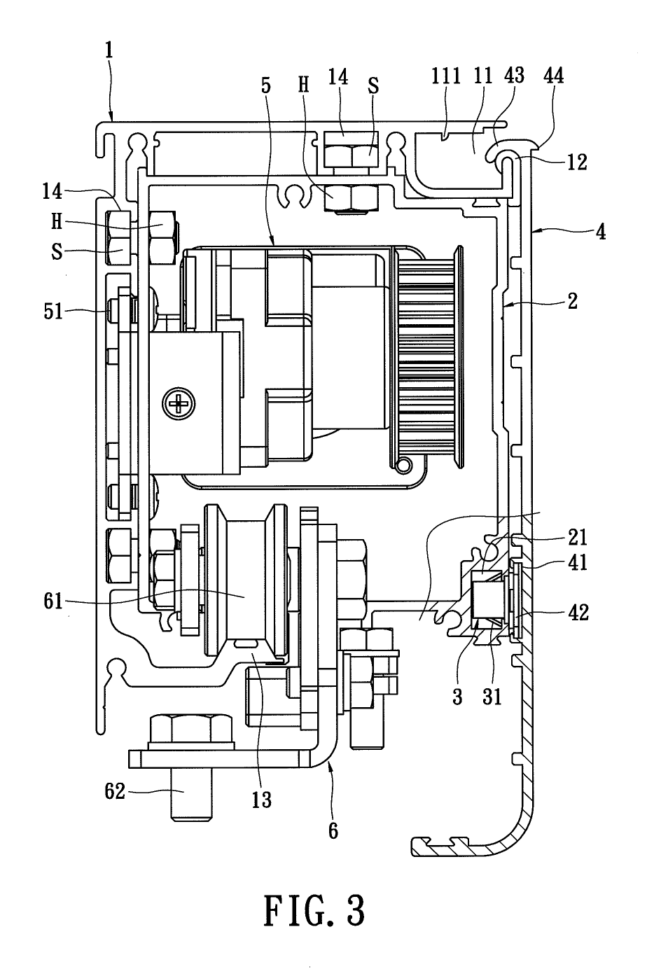

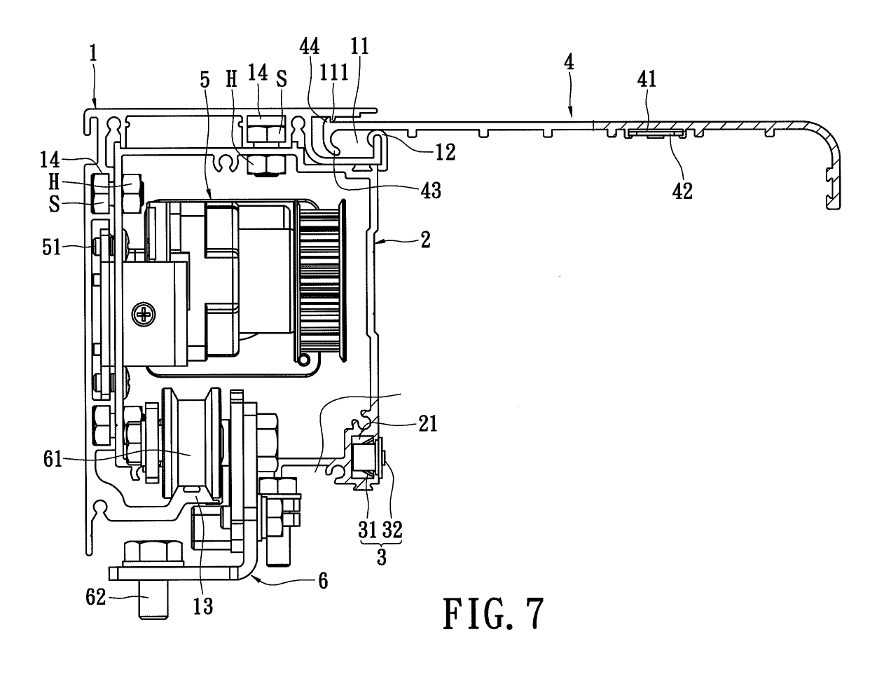

In the embodiment, the cover 4 is disposed on one side of the main frame 1 and may move between a first position (the cover is in a closed state, as shown in FIG. 3) and a second position (the cover is in an open state, as shown in FIG. 7). The cover 4 has a corresponding groove 41, an adsorbed element 42, a hook portion 43 and a protruding portion 44. The corresponding groove 41 is disposed corresponding to the adsorption element 3. The adsorbed element 42 may be a magnetizer or a magnetic element, wherein the magnetizer is a metal element with a magnetic permeability (for example, iron). The adsorbed element 42 is embedded in the corresponding groove 41. The hook portion 43 and the protruding portion 44 are disposed on two opposite sides of one end of the cover 4, the arc surface of the hook portion 43 corresponding to the supporting portion 12.

When the cover 4 is in the first portion, the hook portion 43 holds the supporting portion 12 and the adsorption element 3 adsorbs and fixes the adsorbed element 42.

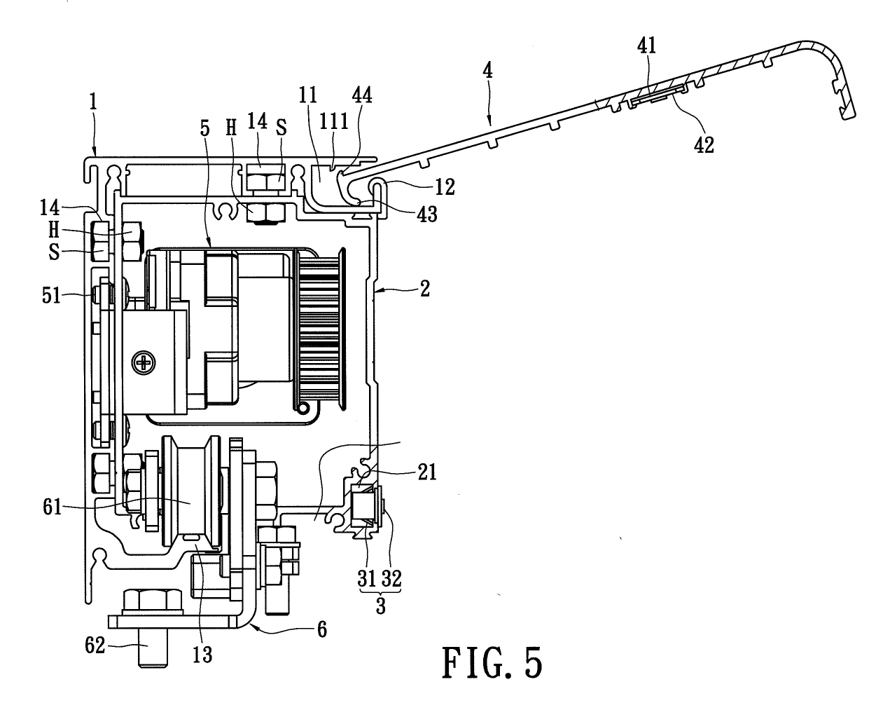

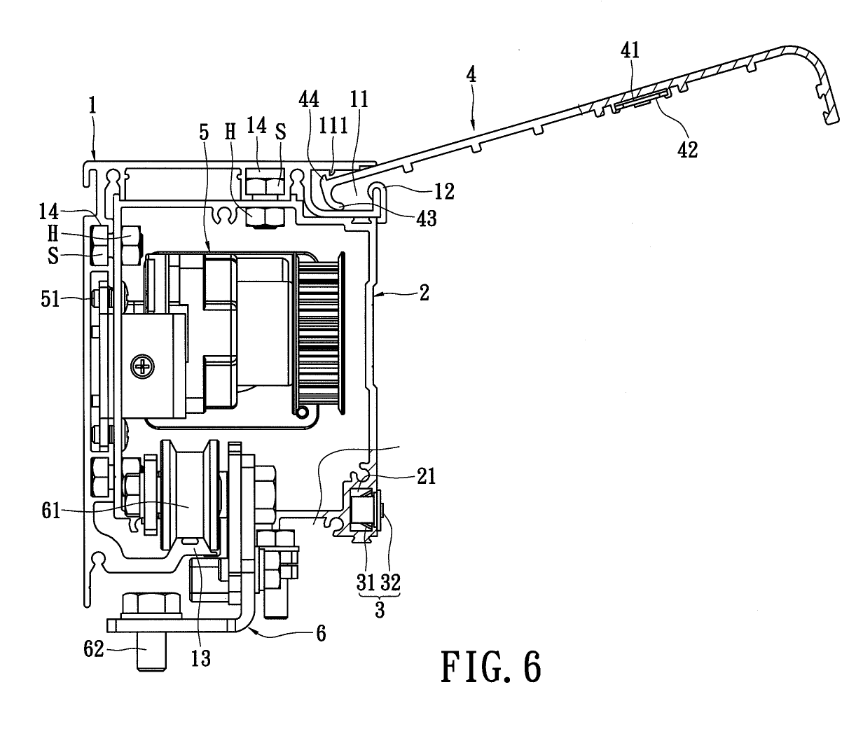

Please refer to FIGS. 4-7, in the process of opening the cover 4, the cover 4 is rotated against the supporting portion 12, the supporting portion 12 is taken as a fulcrum, and then one end of the cover is extended into the revolving groove 11. The cover 4 is rotated to a proper angle so that the vertical height of the protruding portion 44 is lower than the protruding rib 111 (as shown in FIG. 5), and then the cover 4 is pushed in order that the hook portion 43 of the cover 4 moves along the bottom wall in the revolving groove 11 and the protruding portion 44 moves to one side of the protruding rib 111 back to the opening of the revolving groove 11 (as shown in FIG. 6). Finally, the cover 4 is put down so that the protruding portion 44 abuts against the protruding rib 111 and the bottom of the end of the cover 4 abuts against the supporting portion 12 (as shown in FIG. 7), thereby the cover 4 is fixed on one side of the main frame 1 to prevent the cover 4 from falling.

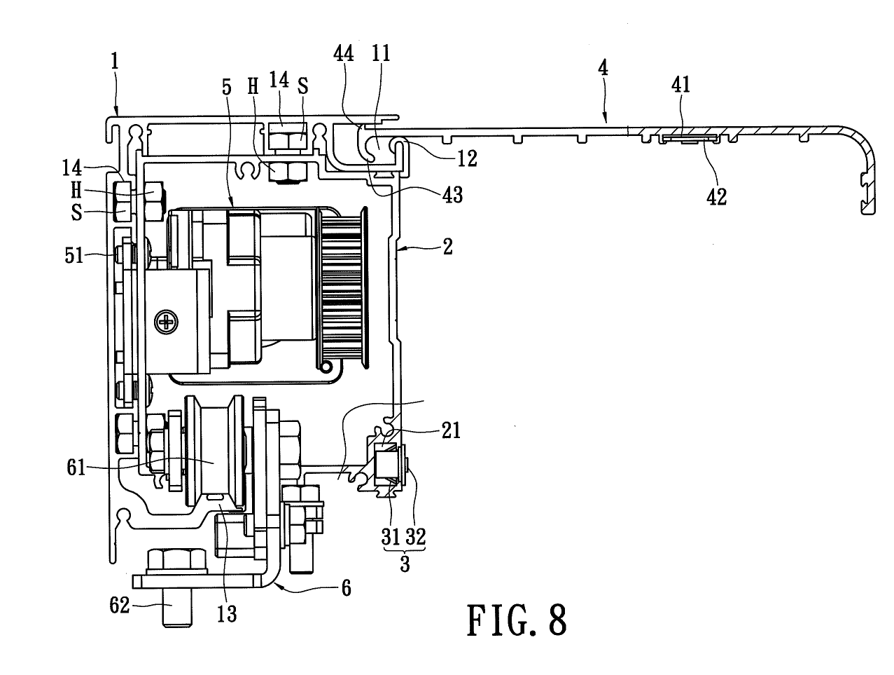

Please refer to FIG. 8, the difference between the embodiment and the above-mentioned embodiment is that if the automatic door case is mounted close to a ceiling, the ceiling will interfere with the cover 4 so that the cover 4 cannot be rotated to a larger angle when the cover 4 is opened. There is no protruding rib 111 disposed on the top wall in the revolving groove 11, so when the cover 4 is in the second position, the protruding portion 44 of the cover 4 abuts against the top wall in the revolving groove 11. Preferably, the vertical height of one end of the cover 4 opposite to the hook portion 43 is slightly higher than the supporting portion 12, so that the cover 4 is fixed on one side of the main frame 1, thereby preventing the cover 4 from falling.

Consequently, the present invention has the advantages as follows:

1. When the cover 4 is in the first position (in the closed state), the adsorption element 3 adsorbs and fixes the adsorbed element 42 so that the cover 4 is fixed on one side of the main frame 1, thereby preventing the cover 4 from falling. Comparing with conventional automatic door cases, the present invention is more convenient for disassembly and assembly.

2. When the cover 4 is in the second position (in the opened state), the protruding portion 44 of the cover 4 abuts against the top wall in the revolving groove 11, the bottom of the cover 4 abuts against the supporting portion 12, and the vertical height of the other end of the cover 4 is slightly higher than the supporting portion 12, so that the cover 4 is fixed on one side of the main frame 1, thereby preventing the cover 4 from falling and enhancing convenience for maintenance and security.

3. When the cover 4 is in the second position, the protruding portion 44 of the cover 4 abuts against the protruding rib 111, so that the cover 4 is fixed on one side of the main frame 1, thereby preventing the cover 4 from falling and enhancing convenience for maintenance and security.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A case cover structure for fall prevention which is applied in automatic sliding doors, comprising:
a main frame;
at least one bearing plate fixed on the main frame and having a receiving groove;
at least one absorption element disposed in the receiving groove of the bearing plate;
a cover disposed on one side of the main frame, and the cover having a corresponding groove opposite to the receiving groove of the bearing plate; and
an absorbed element disposed in the corresponding groove of the cover, wherein the absorption element absorbs and fixes the absorbed element so that the cover is absorbed and fixed to the bearing plate on one side of the main frame.

2. The case cover structure as claimed in claim 1, wherein the absorption element is a magnetic element or a magnetizer.

3. The case cover structure as claimed in claim 1, wherein the absorbed element is a magnetizer or a magnetic element.

4. The case cover structure as claimed in claim 1, wherein the adsorption element has two elastic portions formed on two side edges thereof, respectively, and expanded outwards to abut against an inner wall in the receiving groove.

5. The case cover structure as claimed in claim 1, wherein the main frame further has a driving motor and at least one lift tool disposed therein, and the driving motor is driving-connected with the lift tool.

6. The case cover structure as claimed in claim 5, wherein the main frame has a guideway extended and formed thereon, and the lift tool is slidably disposed on the guideway via at least one rolling wheel.

7. A case cover structure for fall prevention which is applied in automatic doors, comprising:
a main frame having a revolving groove and a supporting portion formed in one side thereof, the supporting portion located at an opening end of the revolving groove; and
a cover disposed on one side of the main frame and having a hook portion and a protruding portion formed on one end of the cover, wherein the cover may move between a first position and a second position, and when the cover is in the first position, the hook portion correspondingly holds the supporting portion; and when the cover is in the second position, one end of the cover extends into the revolving groove, the bottom of the cover abuts against the supporting portion and the protruding portion abuts against a top wall in the revolving groove of the main frame so that the cover is fixed on one side of the main frame.

8. The case cover structure as claimed in claim 7, wherein when the cover is in the second position, a vertical height of the other end of the cover is slightly higher than the supporting portion.

9. The case cover structure as claimed in claim 7, wherein the main frame further has a driving motor and at least one lift tool disposed therein, and the driving motor is driving-connected with the lift tool.

10. The case cover structure as claimed in claim 9, wherein the main frame has a guideway extended and formed thereon, and the lift tool is slidably disposed on the guideway via at least one rolling wheel.

11. A case cover structure for fall prevention which is applied in automatic doors, comprising:
a main frame having a revolving groove and a supporting portion formed in one side thereof, the supporting portion located at an opening end of the revolving groove and a protruding rib protruding from a top wall in the revolving groove of the main frame; and
a cover disposed on one side of the main frame and having a hook portion and a protruding portion formed on one end of the cover, wherein the cover may move between a first position and a second position, and when the cover is in the first position, the hook portion correspondingly holds the supporting portion; and when the cover is in the second position, one end of the cover extends into the revolving groove and the protruding portion abuts against the protruding rib so that the cover is fixed on one side of the main frame.

12. The case cover structure as claimed in claim 11, wherein when the cover is in the second position, an inner wall of one end of the cover abuts against the supporting portion.

13. The case cover structure as claimed in claim 11, wherein the main frame further has a driving motor and at least one lift tool disposed therein, and the driving motor is driving-connected with the lift tool.

14. The case cover structure as claimed in claim 13, wherein the main frame has a guideway extended and formed thereon, and the lift tool is slidably disposed on the guideway via at least one rolling wheel.
